(19) United States
(12) Patent Application Publication
(10) Pub. No.: US 2020/0326207 A1
(43) Pub. Date: Oct. 15, 2020

(54) BEHAVIOR MEASUREMENT AND MAINTENANCE METHOD USING MULTI-AXIS SENSOR

(71) Applicant: HEUNG IN ENC CO., LTD, Seongnam-si, Gyeonggi-do (KR)

(72) Inventor: Young Eok KWON, Seoul (KR)

(21) Appl. No.: 16/096,574

(22) PCT Filed: Apr. 26, 2017
(86) PCT No.: PCT/KR2017/004409

§ 371 Date: Oct. 25, 2018

(30) Foreign Application Priority Data
Apr. 26, 2016 (KR) 10-2016-0050641
Dec. 30, 2016 (KR) 10-2016-0184020

(51) Int. Cl. G01C 25/00; G01C 19/00; G01V 3/08; G01C 9/00; G01P 15/18

(52) U.S. Cl. CPC G01C 25/00; G01C 19/00; G01V 1/16; G01C 9/00; G01P 15/18; G01V 3/08

(57) ABSTRACT

Provided is a behavior measurement and maintenance method using a multi-axis sensor, including the steps of: providing one or more moving pipes such that the moving pipes are penetratively connected while both ends thereof are positioned on the ground along a surface to be measured of a tunnel, a slope, a sewer pipe, a structure and the like; providing one or more multi-axis sensors such that the sensors are connected to a logger exposed to the outside of the moving pipe and move along the inside of the moving pipe; and exposing the multi-axis sensor to the outside of the moving pipe or inserting the same into each moving pipe so as to move the multi-axis sensor to each measuring point along the moving pipe, thereby inserting the multi-axis sensors into the moving pipes so as to simultaneously or successively measure the displacement of each measuring point or discharging the multi-axis sensor from the moving pipe after measurement is completed.

### TECHNICAL FIELD

The present invention relates to a behavior measurement and maintenance method using a multi-axis sensor, the method comprising the steps of: connectedly installing one or more moving pipes to be penetratingly connected each other along a measurement surface of a tunnel, a sloped surface, a sewer pipe, a structure or the like, while both ends thereof are positioned on the ground; installing one or more multi-axis sensor modules connected to a logger exposed on the outside of the moving pipes and moved along the inside of the moving pipes; and exposing the multi-axis sensor modules to the outside of the moving pipes or inserting the multi-axis sensor modules into the moving pipes so that the multi-axis sensor modules may move to measurement points along the moving pipes, wherein the multi-axis sensor modules are inserted into the moving pipes and simultaneously or sequentially measure displacement of the measurement points, or the multi-axis sensor modules are discharged from the moving pipes after the measurement is completed.

### BACKGROUND ART

Generally, a construction method having various preceding works is performed to construct a tunnel.

In addition, a work for confirming a ground condition of a place where the tunnel is to be constructed and a drilling work for inserting blasting materials for blasting are performed as the preceding works described above.

Subsequently, it is possible to confirm the development state and weathering state of joints existing in the rock beds, characteristics of distribution of fracture zones, and existence of flow of underground water by collecting samples after drilling holes at a predetermined depth on a free total cross section where a tunnel is to be conducted.

In addition, behaviors caused by subsidence of a tunnel or the like are measured while blasting for constructing the tunnel is progressed in order.

In addition, even after the tunnel is completed, displacement of the tunnel caused by tremors or the like is measured through a displacement meter or the like buried therein.

In relation to the technique like this, the inventors of the present invention have proposed a technique of a tunnel behavior measurement system using an inclinometer in the Korean Patent registration No. 1482054, and as shown in FIG. 1, the system is configured to connect cables of the inclinometer configured of a measurement sensor 217 to a main cable and connect the main cable to a data logger 400 located on the bottom of the tunnel T. One or more of the measurement sensors 217 are installed inside a plurality of measurement units 500 sequentially connected to determine a position on the excavated surface 100, and when the plurality of measurement units 500 is assembled in correspondence to the excavated surface 100 of the tunnel, the measurement units 500 are installed to be positioned along the excavated surface 100.

However, the measurement system as described above is a configuration in which the measurement units 500 are fixed to the inner side a shotcrete layer formed on the excavated surface and has a disadvantage in that measurement of behaviors is incapable when individual measurement sensors 217 are damaged.

In addition, there is a problem in that since the measurement units 500 are fixedly installed, repeated use of the measurement units 500 is not allowed.

### DISCLOSURE OF INVENTION

### Technical Problem

Therefore, the present invention has been made in view of the above problems, and it is an object of the present invention to provide a behavior measurement and maintenance method using a multi-axis sensor, which can solve the problem of making measurement incapable by easily replacing a sensor when the sensor is defective, allow maintenance of the sensor, easily measure behaviors of each measurement point at a minimum cost, reduce the measurement cost as repeated use of the sensor is allowed, and confirm behaviors in the entire measurement area through a minimum number of sensors.

### Technical Solution

To accomplish the above object, according to one aspect of the present invention, there is provided a behavior measurement and maintenance method using a multi-axis sensor, the method comprising the steps of: installing a plurality of moving pipes in a measurement area to be penetratingly connected to each other and while being fixed to be buried or exposed along a measurement surface; installing one or more multi-axis sensor modules connected to a logger exposed to the outside and moved along the inside of the moving pipes; and exposing the multi-axis sensor modules to the outside of the moving pipes or inserting the multi-axis sensor modules into the moving pipes so that the multi-axis sensor modules may move to measurement points along the moving pipes, wherein the multi-axis sensor modules are inserted into the moving pipes and simultaneously or sequentially measure displacement of the measurement points, or the multi-axis sensor modules are discharged from the moving pipes after the displacement measurement at each measurement point is completed.

In addition, the multi-axis sensor modules are installed to transfer a measurement value to the logger in real-time while passing the measurement points located inside the moving pipes without stopping, and the multi-axis sensor modules are configured of a combination of one or more selected among a gyro sensor, an acceleration sensor, a geomagnetic sensor and an inclinometer sensor.

In addition, a plurality of multi-axis sensor modules is connected each other as one body along a cable in correspondence to the measurement points of the moving pipes.

In addition, one or more multi-axis sensor modules, less than the total number of the measurement points, are connectedly installed to measure while moving along the measurement points of the moving pipes.

In addition, one or more multi-axis sensor modules are separated and connected each other to measure while moving from the first measurement point after dividing the total length of the moving pipes into equal intervals.

Subsequently, the multi-axis sensor module is connected using a cable when the multi-axis sensor module is embedded in a sensor block, and the sensor block and the cable are connected using a reinforcement wire.

In addition, the sensor block is inserted through a guide groove provided in the moving pipe sand moves along right positions.

In addition, the sensor block further includes a wheel, and a driving motor to which power is supplied through the cable is connected to the wheel so that the multi-axis sensor module may autonomously move.

In addition, sliding wheels are provided at both exposed ends of the moving pipes to infinitely move a guide wire so that the sensor block connected to the guide wire may be installed to move along the moving pipes.

Subsequently, the moving pipes are installed in parallel to be adjacent to each other in a progress direction of a tunnel, and sensor blocks inserted in the moving pipes measure displacement while moving in different directions on the same straight line of the progress direction.

In addition, a plurality of moving pipes is installed at regular intervals in a progress direction of a tunnel, and sliding wheels are provided at both exposed ends of the moving pipes to infinitely move a guide wire so that sensor blocks connected to the guide wire may move along the moving pipes, and a sensor block that has completed measurement is discharged from the moving pipe and inserted into another moving pipe where measurement is desired and measures displacement.

### Advantageous Effects

According to the present invention as described above, there is an effect of solving the problem of making measurement incapable by easily replacing a sensor when the sensor is defective, allowing maintenance of the sensor, easily measuring behaviors of each measurement point at a minimum cost, reducing the measurement cost as repeated use of the sensor is allowed, and confirming behaviors in the entire measurement area through a minimum number of sensors.

### BRIEF DESCRIPTION OF THE DRAWINGS

FIG. 1 is a cross-sectional view showing a conventional tunnel behavior measurement system using an inclinometer.

FIG. 2 is cross-sectional view showing a behavior measurement and maintenance method according to the present invention.

FIG. 3 is a cross sectional view showing a behavior measurement and maintenance method according to another embodiment of the present invention.

FIG. 4 is a cross-sectional view showing a major portion in a behavior measurement and maintenance method according to the present invention.

FIG. 5 is a view showing a sequence of work of a behavior measurement and maintenance method according to the present invention.

FIGS. 6 to 8 are cross-sectional views respectively showing a behavior measurement and maintenance method according to other embodiments of the present invention.

FIGS. 9 and 10 are views respectively showing an application state of a moving pipe according to still another embodiment of the present invention.

FIGS. 11 to 13 are views respectively showing a measurement state of a sensor block according to still another embodiment of the present invention.

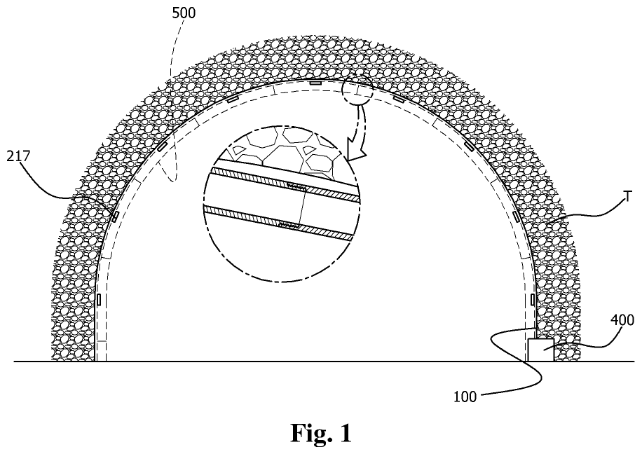

### BEST MODE FOR CARRYING OUT THE INVENTION

Hereinafter, the embodiments of the present invention are described in detail with reference to the accompanying drawings.

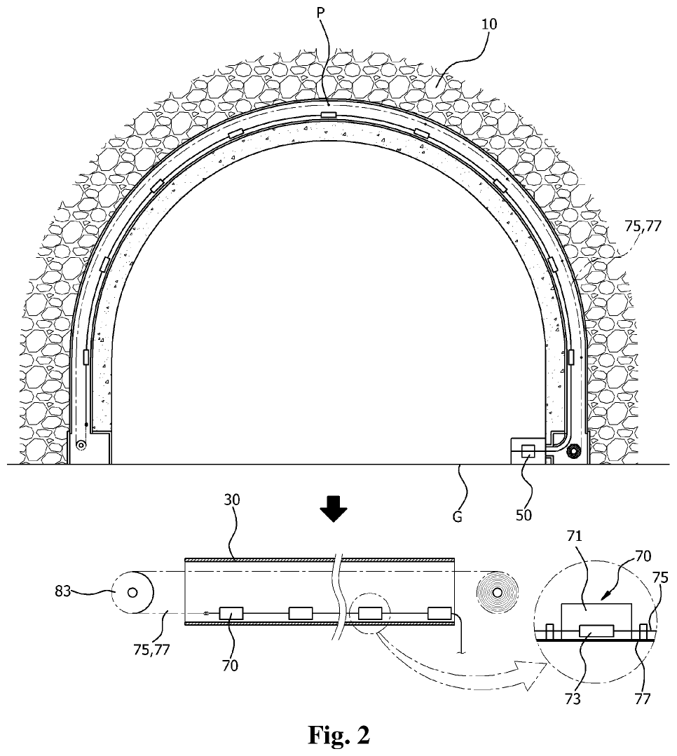

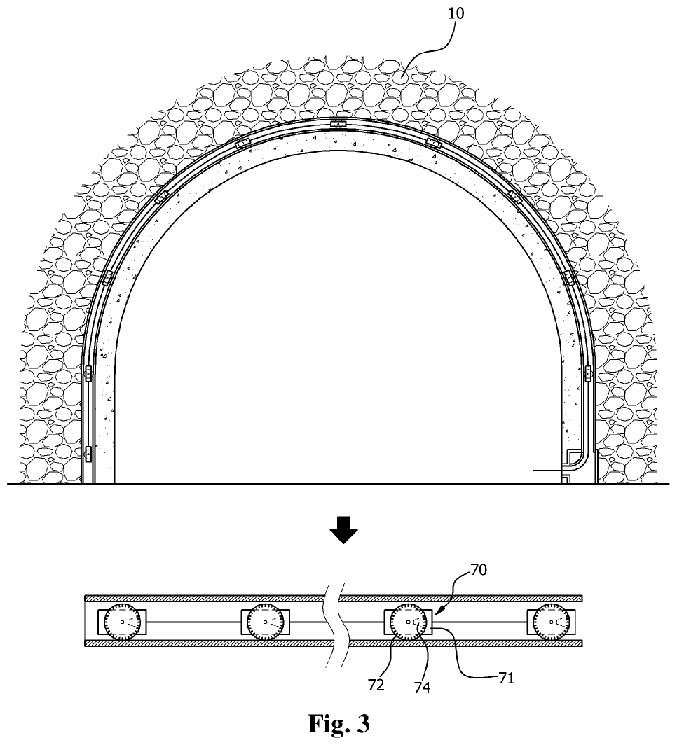

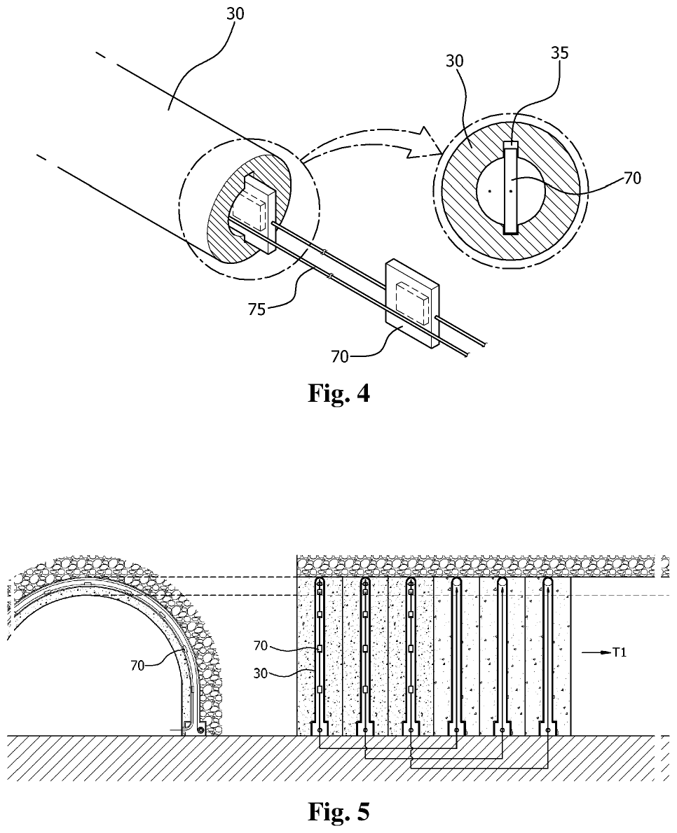

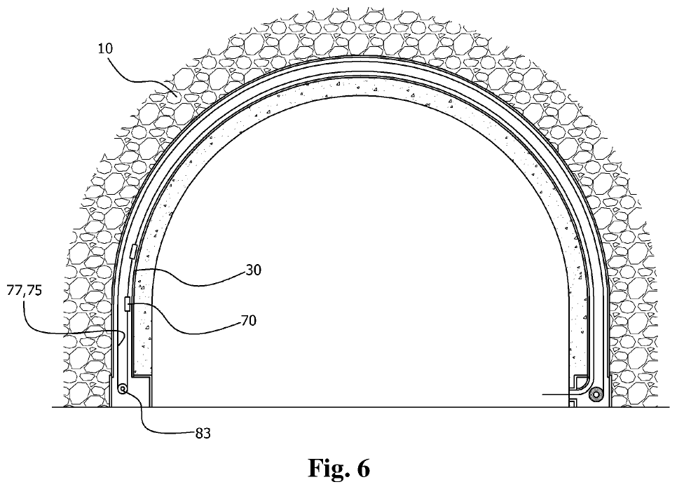

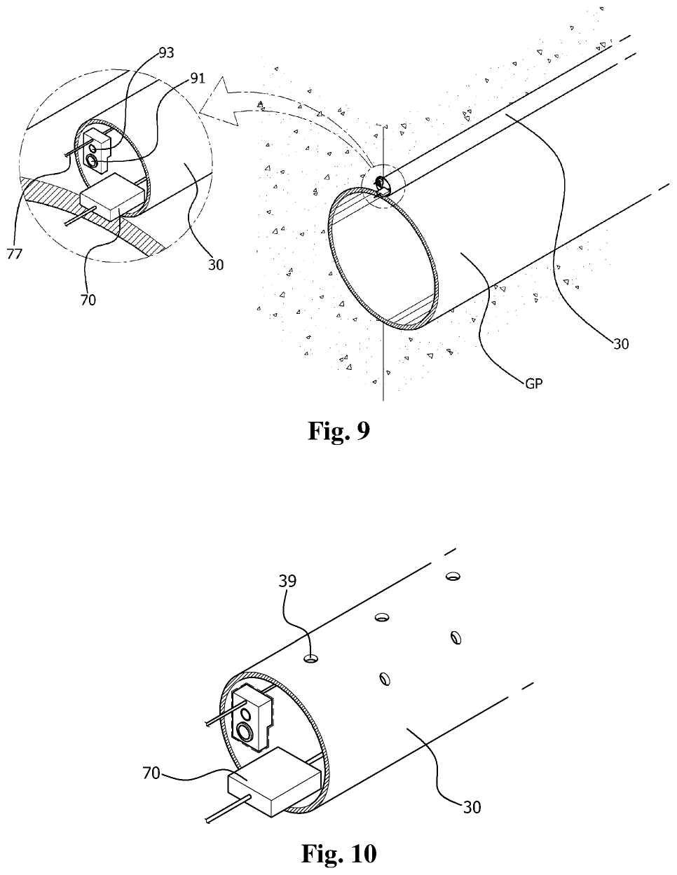

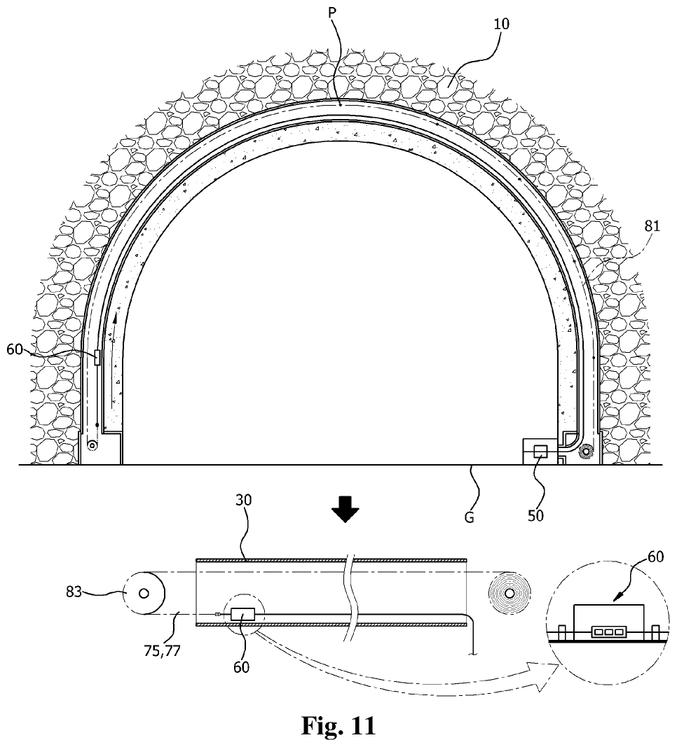

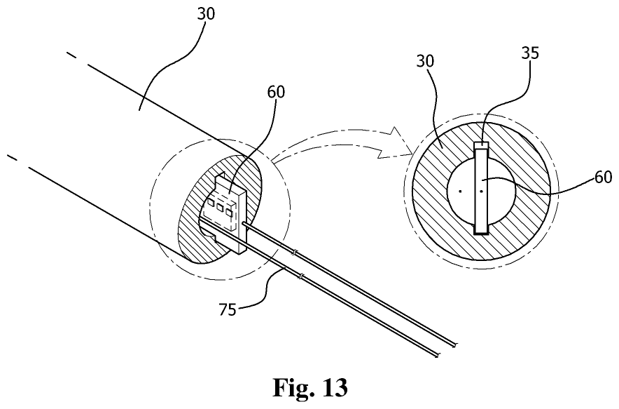

FIG. 2 is cross-sectional view showing a behavior measurement and maintenance method according to the present invention, FIG. 3 is a cross sectional view showing a behavior measurement and maintenance method according to another embodiment of the present invention, FIG. 4 is a cross-sectional view showing a major portion in a behavior measurement and maintenance method according to the present invention, FIG. 5 is a view showing a sequence of work of a behavior measurement and maintenance method according to the present invention, FIGS. 6 to 8 are cross-sectional views respectively showing a behavior measurement and maintenance method according to other embodiments of the present invention, FIGS. 9 and 10 are views respectively showing an application state of a moving pipe according to still another embodiment of the present invention, and FIGS. 11 to 13 are views respectively showing a measurement state of a sensor block according to still another embodiment of the present invention.

In the present invention, displacement according to a stress acted on a measurement surface is measured through one or more multi-axis sensor modules installed along a measurement surface 10 configured of an installation surface of a place, deformation of which is desired to be measured, such as a tunnel of an arc shape, an inner or outer surface of a structure, a sloped surface, a sewer pipe or the like.

At this point, a plurality of moving pipes 30 is installed on the measurement surface 10 to be penetratingly connected each other so that the displacement may be measured by the multi-axis sensor modules moving inside thereof.

In addition, the moving pipes 30 may be screw-connected each other or connected through a coupling means (not shown) and exposed or buried along the measurement surface 10 while having a predetermined length.

In addition, a logger 50 is installed to be exposed at one side of the moving pipes 30, while being connected to the multi-axis sensor modules inserted in the moving pipes 30, so that a manager may easily access from the outside of the moving pipes.

In addition, one or more multi-axis sensor modules 70 are connectedly installed to move along the inside of the moving pipes 30 while being electrically connected to the logger 50.

At this point, the multi-axis sensor modules 70 are installed to autonomously or manually move inside the moving pipes while being electrically connected through one or more cables to supply signals and power.

Subsequently, a three-axis sensor 73 such as an inclinometer sensor or an acceleration sensor is individually installed in the multi-axis sensor module 70, or the multi-axis sensor module 70 uses a multi-axis sensor 60 in which a gyro sensor, an acceleration sensor, a geomagnetic sensor and an inclinometer sensor are simultaneously connected in one chip.

At this point, a plurality of multi-axis sensor modules 70 may be simultaneously connected inside the moving pipes in correspondence to measurement points P, respectively.

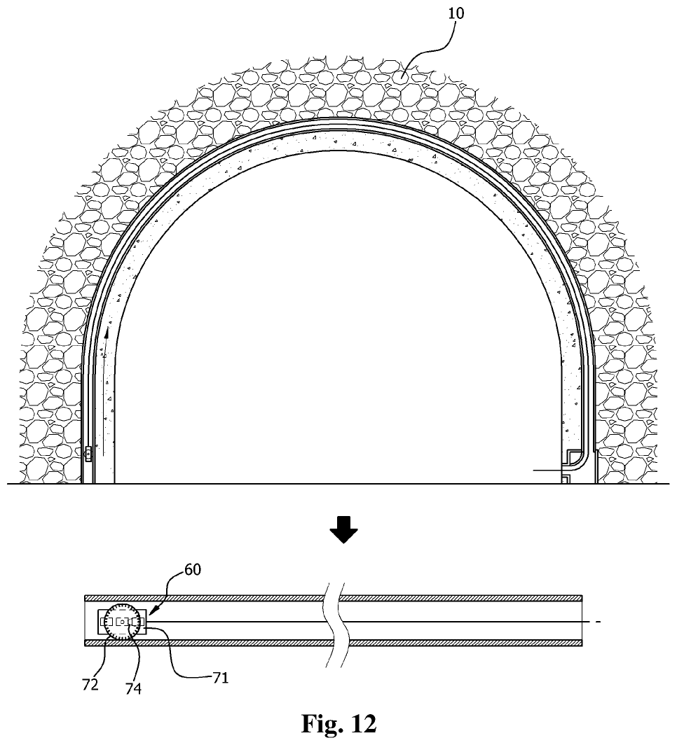

In addition, as shown in FIG. 12, when the multi-axis sensor module 70 utilizing the multi-axis sensor 60 is used, it does not need to use a plurality of multi-axis sensor modules corresponding to the measurement points P located inside the moving pipes, and displacement of a measurement point may be recorded while transmitting a displacement value in real-time without stopping at a desired measurement point P when a multi-axis sensor module is moved along the inside of the moving pipes without stopping.

That is, when displacement is measured through the multi-axis sensor module 70, a data thereof is inputted and processed in a predetermined program to predict a current state, precedent changes or the like of the tunnel and prevent accidents.

In addition, the displacement value is transmitted to the logger 50 using one or more communication methods by selection of a user among wired and wireless communications such as ZigBee communication, Bluetooth, RS-485 communication, Ethernet and the like.

At this point, the multi-axis sensor module 70 may further include a communication module as described above to transmit, and the measured displacement value may be transmitted to the logger through the communication methods as described above or directly transmitted to a separate external data collection means.

That is, since the multi-axis sensor module 70 using a multi-axis sensor uses a gyro sensor for recognizing a slope, an acceleration sensor for recognizing a moving state, and a geomagnetic sensor for measuring a direction, a displacement value at each measurement point, as well as the measurement point, can be known, and thus the displacement value at each measurement point P is confirmed in real-time without stopping.

At this point, an encoder may be further connected to the cable connected to the multi-axis sensor modules 70 or to a reinforcement wire 77 supporting the cable 75 for double confirmation of a moving distance.

In addition, the multi-axis sensor modules 70 are exposed to the outside of the moving pipes 30 or moved along the inside of the moving pipes to be positioned at the measurement points P, respectively.

At this point, the multi-axis sensor modules 70 may be simultaneously installed at the measurement points P located in the moving pipes and simultaneously measure displacement of the measurement points, or only some of the multi-axis sensor modules 70 may be installed to sequentially move and stop at measurement points P and measure displacement.

In addition, the multi-axis sensor modules 70 are installed to be discharged to the outside of the moving pipes when the measurement work of the multi-axis sensor modules 70 at the measurement points is completed or for maintenance purpose.

In addition, a plurality of multi-axis sensor modules 70 is simultaneously connected in correspondence to the measurement points P located in the moving pipes, respectively.

In addition, the multi-axis sensor modules 70, at least one less than the total number of measurement points P, are provided to measure displacement while moving along the measurement points P of the moving pipes 30.

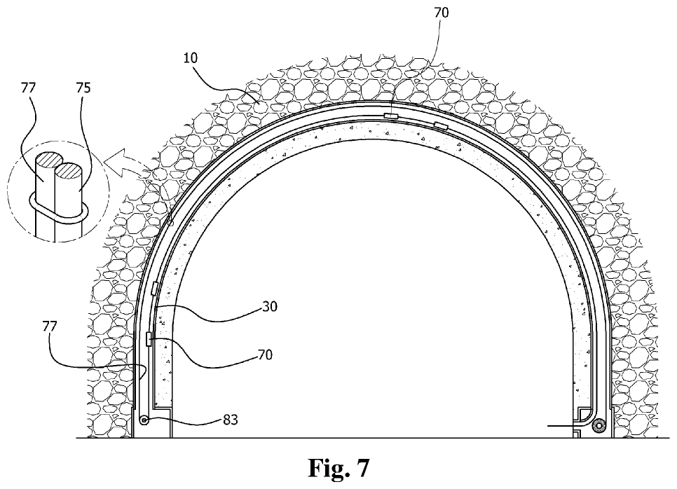

Specifically describing the present invention configured as described above, after dividing the total length of a plurality of moving pipes connected as shown in FIGS. 6 and 7 into equal intervals in correspondence to the measurement points, one or more multi-axis sensor modules respectively mounted with a three-axis sensor or a multi-axis sensor are separated and connected each other to measure displacement while moving from the divided first measurement point P.

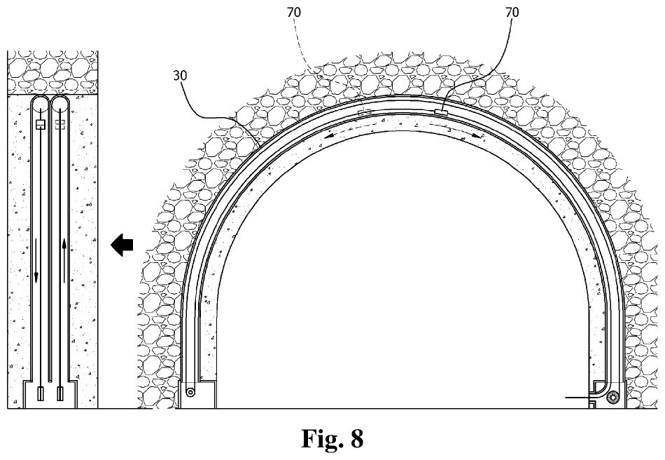

That is, only one multi-axis sensor module is installed to correspond only to the first measurement point as shown in FIG. 8 to measure while continuously moving, or the multi-axis sensor modules are installed in correspondence to the first and the center measurement points as shown in FIG. 7 to move only half of the entire length and measure at all measurement points.

Subsequently, when the three-axis sensor 73 is embedded inside the sensor block 71, the multi-axis sensor module 70 is connected using the cable 75 and supply or transfer signals or power.

In addition, it is possible to use a multi-axis sensor module of a configuration having a multi-axis sensor 60 installed inside the sensor block 71, in which a gyro sensor, an acceleration sensor, a geomagnetic sensor and an inclinometer sensor are simultaneously connected in a single chip, and the multi-axis sensor module is also connected using the cable.

At this point, although the sensor block may be towed through the connected cable 75, it is preferable to connect through a separate reinforcement wire 77 since there is a problem of cable cutting when tension is acted.

In addition, a plurality of sliding wheels 83 is provided at both exposed ends and at an inner side of the moving pipes, and if the reinforcement wire or the cable connected thereto is pulled, the multi-axis sensor module moves along the inside of the moving pipes.

At this point, the multi-axis sensor module is installed to move to a right position while the sensor block is inserted through a guide groove 35 provided in the moving pipes 30.

In addition, the sensor block 71 further includes a wheel 72, and a driving motor 74 to which power is supplied through the cable is connected to the wheel so that the multi-axis sensor module may autonomously move when power is supplied through the cable.

At this point, an encoder or the like is attached to the wheel 72 to confirm a moving distance so that the multi-axis sensor module may move to a right position corresponding to the location of a measurement point P.

In addition, as the sliding wheels 83 are respectively provided at both exposed ends of the moving pipes 30 so that the reinforcement wire 81 passing through the moving pipes may move infinitely, the multi-axis sensor module combined with the reinforcement wire is installed to move along the moving pipes when the reinforcement wire is pulled to a direction.

At this point, an encoder (not shown) is further attached to each sliding wheel 83, and a degree of winding or unwinding of the reinforcement wire may be known as a distance.

Subsequently, as shown in FIG. 5, the moving pipes 30 are installed in parallel to be adjacent to each other in the progress direction T1 of the tunnel.

At this point, the multi-axis sensor modules 70 inserted in the moving pipes 30 may measure while moving in different directions.

In addition, a plurality of moving pipes 30 is installed at regular intervals in the progress direction T1 of the tunnel, and measurement is sequentially performed by discharging a multi-axis sensor module that has completed measurement in a moving pipe and inserting the multi-axis sensor module into another moving pipe where measurement is desired.

At this point, as the reinforcement wire 77 and the sliding wheels 83 are provided inside the moving pipes to infinitely move the reinforcement wire, if the multi-axis sensor modules are connected to the reinforcement wire, each of the multi-axis sensor modules connected to the reinforcement wire is consecutively inserted into the moving pipes and measures behaviors of each measurement point.

In addition, although an application state of a tunnel is described in the present invention, the moving pipes 30 may be installed in a sloped surface, a bridge, a structure, a sewer pipe GP or the like as shown in FIGS. 9 and 10, and deformation thereof may be known.

In addition, the moving pipe 30 further includes inlet holes 39 formed at least on one side as one body to easily drain water or the like flowing in through the ground surface when it is installed in a sewer pipe, a tunnel, a sloped surface or the like.

Subsequently, a camera 91 and an LED 93 are further provided at one side of the reinforcement wire 77 or the multi-axis sensor module 70 installed inside the moving pipe 30 as shown in FIG. 9 so that the multi-axis sensor module 70 may move while easily watching the inside of the moving pipe.

In addition, as shown in FIGS. 11 to 13, since the multi-axis sensor module 70 uses a multi-axis sensor 60 in which a gyro sensor, an acceleration sensor, a geomagnetic sensor and an inclinometer sensor are simultaneously connected in one chip, one multi-axis sensor module 70 is moved along the inside of the moving pipes without installing a sensor in correspondence to each measurement point P, and displacement at each measurement point P is confirmed in real-time by determining, at each measurement point P using a previously stored program, the slope, speed, direction and the like provided by the multi-axis sensor module when the multi-axis sensor module 70 is moved.

In addition, the multi-axis sensor 60 in which a gyro sensor, an acceleration sensor, a geomagnetic sensor and an inclinometer sensor are simultaneously connected in a single chip is installed inside the sensor block 71, and the multi-axis sensor module 70 is connected to the cable 75.

At this point, the multi-axis sensor module provided with the multi-axis sensor may be moved by a cable, a reinforcement wire connected thereto and the like, and as the wheel 72 is further provided, the driving motor 74 to which power is supplied through the cable is further connected, and the multi-axis sensor module may autonomously move when power is supplied through the cable.

In addition, the multi-axis sensor module may be installed to move to a right position while the sensor block is inserted through a guide groove 35 provided in the moving pipe 30.

### INDUSTRIAL APPLICABILITY

The present invention relates to a technique of installing a sensor for measuring displacement of a tunnel or the like not in a fixed method of burying the sensor, but in a mobile method, in which a plurality of multi-axis sensors positioning in correspondence to measurement points is inserted inside the moving pipes installed along a measurement surface of a tunnel, a sloped surface, a sewer pipe, a structure or the like to simultaneously or sequentially measure displacement of each measurement point, or the multi-axis sensors are discharged from the moving pipes after measurement is completed, and thus the multi-axis sensors of high price can be repetitively used.

1. A behavior measurement and maintenance method using a multi-axis sensor, the method comprising the steps of:
installing one or more moving pipes along a measurement surface to be penetratingly connected each other in correspondence to the measurement surface;
installing one or more multi-axis sensor modules connected to a logger exposed on the outside of the moving pipes and moved or stopped along the inside of the moving pipes; and
exposing the multi-axis sensor modules to the outside of the moving pipes or inserting the multi-axis sensor modules into the moving pipes so that the multi-axis sensor modules may move to measurement points along the moving pipes, wherein
the multi-axis sensor modules are inserted into the moving pipes and simultaneously or sequentially measure displacement of the measurement points, or the multi-axis sensor modules are discharged from the moving pipes after the measurement is completed.

2. The method according to claim 1, wherein the multi-axis sensor in which a gyro sensor, an acceleration sensor, a geomagnetic sensor and an inclinometer sensor are simultaneously connected is used, and the multi-axis sensor module measures displacement of the measurement points in real-time while moving along the moving pipes without stopping.

3. The method according to claim 1, wherein a three-axis sensor selected among an inclinometer sensor and an acceleration sensor is used, and a plurality of multi-axis sensor modules is simultaneously installed to be connected each other in correspondence to the measurement points of the moving pipes, and thus the multi-axis sensor modules simultaneously measure displacement of the measurement points.

4. The method according to claim 1, wherein a three-axis sensor selected among an inclinometer sensor and an acceleration sensor is used, and one or more multi-axis sensor modules, less than the total number of the measurement points, are connected to sequentially measure while moving along the measurement points of the moving pipes, and thus the multi-axis sensor modules measure displacement of the measurement points moving from one measurement point to another measurement point after measuring displacement of the one measurement point.

5. The method according to claim 1, wherein a three-axis sensor selected among an inclinometer sensor and an acceleration sensor is used, and one or more multi-axis sensor modules are installed to be separated along a cable to measure while moving from a first measurement point after dividing a total length of the moving pipes into equal intervals.

6. The method according to claim 1, wherein the multi-axis sensor module is connected using a cable when the multi-axis sensor module is embedded in a sensor block, and the sensor block and the cable are connected using a reinforcement wire.

7. The method according to claim 1, wherein the sensor block moves to a right position through a guide groove provided in the moving pipes, and a camera and an LED are further connected to the sensor block.

8. The method according to claim 6, wherein the sensor block further includes a wheel, and a driving motor to which power is supplied through the cable is connected to the wheel so that the multi-axis sensor module may autonomously move.

9. The method according to claim 1, wherein sliding wheels are provided at both exposed ends of the moving pipes to infinitely move a reinforcement wire so that sensor blocks connected to the reinforcement wire may be installed to move along the moving pipes, and a plurality of inlet holes is penetratingly formed at least on one side of the moving pipes.

10. The method according to claim 1, wherein the moving pipes are installed in parallel to be adjacent to each other in a progress direction of a tunnel, and sensor blocks inserted in the moving pipes measure displacement while moving in different directions.

11. The method according to claim 1, wherein a plurality of moving pipes is installed at regular intervals in a progress direction of a tunnel, and sliding wheels are provided at both exposed ends of the moving pipes to infinitely move a reinforcement wire so that sensor blocks connected to the reinforcement wire may move along the moving pipes, and a sensor block that has completed measurement is discharged from the moving pipe and inserted into another moving pipe where measurement is desired and measures displacement.

12. The method according to claim 1, wherein the measurement surface includes a sloped surface, a tunnel of an arc shape, an inner or outer surface of a structure, a sloped surface, and an installation surface of a sewer pipe.

13. The method according to claim 2, wherein the sensor block moves to a right position through a guide groove provided in the moving pipes, and a camera and an LED are further connected to the sensor block.
